(19) United States
(12) Patent Application Publication
(10) Pub. No.: US 2019/0101679 A1
(43) Pub. Date: Apr. 4, 2019

(54) LIGHT EMITTING DEVICE AND LIQUID CRYSTAL DISPLAY DEVICE

(71) Applicant: SHARP KABUSHIKI KAISHA, Sakai City (JP)

(72) Inventors: HIROSHI KITAMURA, Sakai City (JP); HIDEKAZU FUJII, Sakai City (JP); KENICHI MURAKOSHI, Sakai City (JP); MAKOTO AGATANI, Sakai City (JP)

(21) Appl. No.: 16/151,308

(22) Filed: Oct. 3, 2018

(30) Foreign Application Priority Data
Oct. 4, 2017 (JP) 2017-194504

(51) Int. Cl. F21V 8/00; G02F 1/13357

(52) U.S. Cl. CPC G02B 6/001; G02F 2001/133628; G02F 1/1336

(57) ABSTRACT

A light emitting device includes a first light source unit and a second light source unit that emit three or more types of laser light beams having wavelengths different from each other, a light guide portion in which the laser light beams emitted from both the first light source unit and the second light source unit are guided, and a first heat sink and a second heat sink that respectively hold the first light source unit and the second light source unit at predetermined positions, and dissipate heat generated from the first light source unit and the second light source unit.

### BACKGROUND

### 1. Field

The present disclosure relates to a light emitting device and a liquid crystal display device including the light emitting device.

### 2. Description of the Related Art

So far, various liquid crystal display devices such as a liquid crystal TV are developed. For example, in Eiji Niikura, “An RGB laser-backlit liquid crystal display”, ITU Journal Vol. 46 No. 2 (2016, 2), pp. 32-35 (hereinafter referred to as Non-Patent Document 1), a liquid crystal display device is disclosed. In the liquid crystal display device, a surface light source is implemented by alternately arranging a laser diode of emitting red (R) light, a laser diode of emitting green (G) light, and a laser diode of emitting blue (B) light on the left and right in a longitudinal direction of the liquid crystal display device and by arranging a light guide rod for each laser diode.

In addition, in Japanese Unexamined Patent Application Publication No. 2017-091984, a surface light emitting device including a laser element, a linear light guide rod for guiding laser light, and a light guide plate for converting light into surface-emitting light and emitting the converted light, is disclosed.

In addition, Japanese Unexamined Patent Application Publication No. 2015-128011 discloses a light emitting device including a white light-emitting diode (LED) as a light source and a linear transparent light guide portion for emitting light from the light source.

In addition, Japanese Unexamined Patent Application Publication No. 2016-075872 discloses a liquid crystal display device including a heat sink with high efficiency that directly and efficiently propagates heat generated from a laser diode.

However, in the liquid crystal display device of Non-Patent Document 1, since the laser light emitting monochromatic light of any one of red, green, and blue colors is guided to corresponding one of the light guide rods, there is a problem that color mixing property of the laser light is reduced. In addition, in the liquid crystal display device of Non-Patent Document 1, there is another problem that, in order to realize uniform surface emission, a space/distance is desired between the light guide rods and a liquid crystal panel, which increases a thickness of the liquid crystal display device. In addition, there is a further problem that an auxiliary member (for example, a flatter structure) for improving the color mixing property is desired, resulting in an increase in cost.

In addition, in the surface light source device of Japanese Unexamined Patent Application Publication No. 2017-091984, an arrangement of the laser elements is not specified, and furthermore, the light guide rod and the light guide plate, which are two different light guide members, are used in combination. Therefore, there is a problem that the thickness, weight, and cost of the surface light source device increase and merchantability is reduced.

In addition, according to the light emitting device of Japanese Unexamined Patent Application Publication No. 2015-128011 and Japanese Unexamined Patent Application Publication No. 2016-075872, since it is difficult to align the light source and the light guide portion, there is a possibility that the efficiency of light incident on the light guide portion is deteriorated.

It is desirable to provide a light emitting device capable of realizing uniform surface emission by using a simple and efficient configuration and a liquid crystal display device including such a light emitting device.

### SUMMARY

According to an aspect of the disclosure, there is provided a light emitting device including at least one light source unit that emits three or more types of laser light beams having wavelengths different from each other, a light guide portion in which the laser light beams are guided, and a heat dissipating member that holds the light source unit and the light guide portion at predetermined positions, and dissipates heat generated from the light source unit.

### BRIEF DESCRIPTION OF THE DRAWINGS

FIG. 1 is an exploded perspective view schematically illustrating a liquid crystal display device including a light emitting device according to Embodiment 1 of the present disclosure;

FIG. 2 is a front view schematically illustrating the light emitting device illustrated in FIG. 1;

FIG. 3 is a perspective view schematically illustrating part of the light emitting device when the light emitting device illustrated in FIG. 2 is viewed from a left surface side;

FIGS. 4A and 4B are exploded perspective views schematically illustrating part of the light emitting device when the light emitting device illustrated in FIG. 2 is viewed from a light guide rod side, FIG. 4A is a perspective view of the light emitting device when the light emitting device is viewed from the light guide rod side, and FIG. 4B is a sectional view taken along line IVB-IVB of the periphery of a heat sink illustrated in FIG. 4A;

FIG. 5 is a graph illustrating an example of a relationship between a wavelength of laser light emitted from a first light source unit and a light emission intensity peak;

FIGS. 6A and 6B are schematic diagrams schematically illustrating a modification example of a light guide rod according to Embodiment 1 of the present disclosure;

FIGS. 7A and 7B are diagrams for explaining a heat sink according to a first modification example, FIG. 7A is a perspective view schematically illustrating part of a configuration of the periphery of the heat sink, and FIG. 7B is a sectional view taken along line VIIB-VIIB illustrated in FIG. 7A;

FIGS. 8A and 8B are diagrams for explaining a heat sink according to a second modification example, FIG. 8A is a perspective view schematically illustrating part of a configuration of the periphery of the heat sink, and FIG. 8B is a sectional view taken along line VIIIB-VIIIB illustrated in FIG. 8A;

FIGS. 9A and 9B are diagrams for explaining a heat sink according to a third modification example, FIG. 9A is a perspective view schematically illustrating part of a configuration of the periphery of the heat sink, and FIG. 9B is a sectional view taken along line IXB-IXB illustrated in FIG. 9A;

FIG. 10 is a schematic diagram schematically illustrating part of a light emitting device including a substrate according to a modification example;

FIG. 11 is a schematic diagram schematically illustrating part of the light emitting device including a chassis according to a modification example;

FIG. 12 is a schematic diagram schematically illustrating part of a light emitting device according to Embodiment 2 of the present disclosure;

FIG. 13 is a schematic diagram schematically illustrating part of a light emitting device according to Embodiment 3 of the present disclosure; and

FIG. 14 is a schematic diagram schematically illustrating part of a light emitting device according to Embodiment 4 of the present disclosure.

### DESCRIPTION OF THE EMBODIMENTS

### Embodiment 1

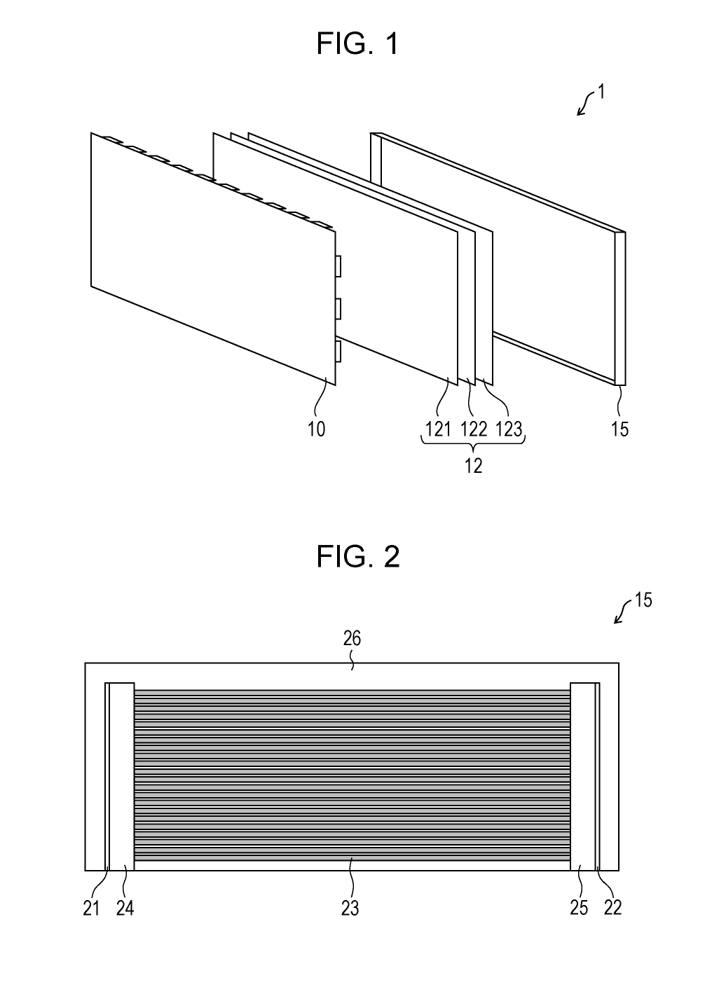

First, a liquid crystal display device including a light emitting device according to an embodiment of the present disclosure will be described with reference to FIG. 1.

Configuration of Liquid Crystal Display Device

FIG. 1 is an exploded perspective view schematically illustrating a liquid crystal display device including a light emitting device according to Embodiment 1 of the present disclosure.

As illustrated in FIG. 1, a liquid crystal display device 1 according to the present embodiment includes a liquid crystal panel 10, an optical sheet 12, and a light emitting device 15 as a backlight.

The liquid crystal panel 10 is a display panel of displaying an image, based on an input electric signal. The optical sheet 12 is provided to focus and diffuse light emitted from the light emitting device 15 and emit efficiently the light to the liquid crystal panel 10. Although the optical sheet 12 in the present embodiment includes a brightness enhancement sheet 121, a prism sheet 122, and a diffuser sheet 123, a configuration of the optical sheet 12 is not limited thereto.

Configuration of Light Emitting Device

Next, the light emitting device 15 according to the present embodiment will be described with reference to FIG. 2 to FIG. 5 in detail.

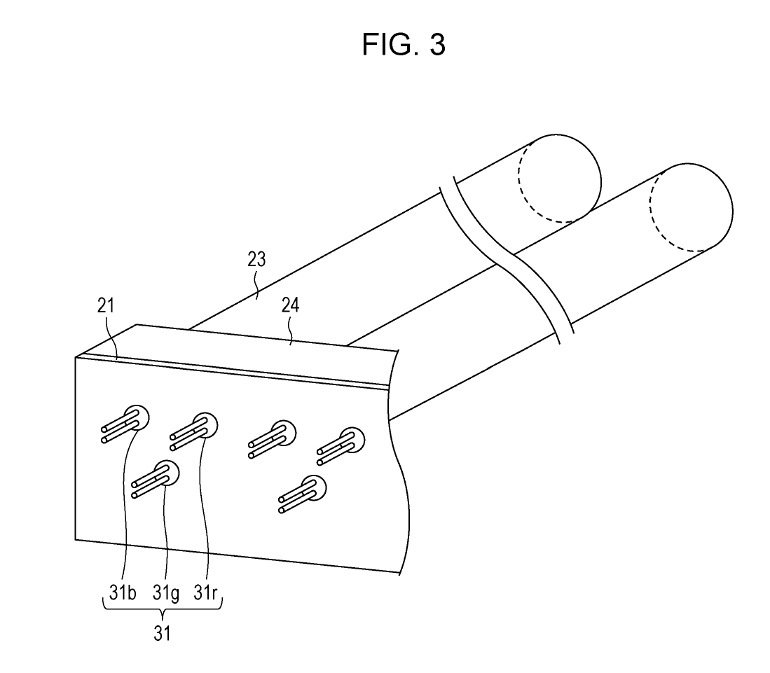

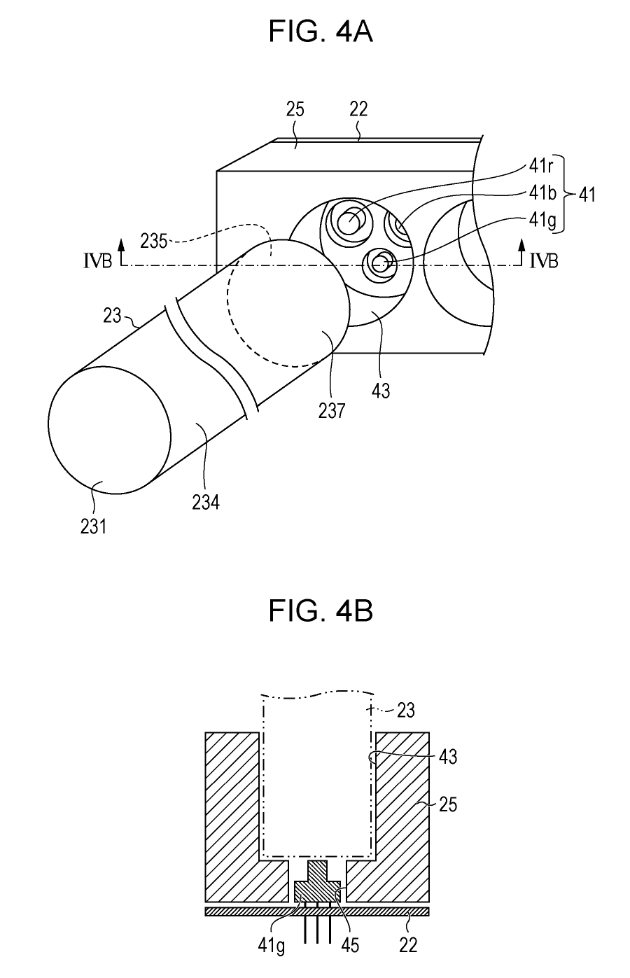

FIG. 2 is a front view schematically illustrating the light emitting device illustrated in FIG. 1. FIG. 3 is a perspective view schematically illustrating part of the light emitting device when the light emitting device illustrated in FIG. 2 is viewed from a left surface side. FIGS. 4A and 4B are perspective views schematically illustrating part of the light emitting device when the light emitting device illustrated in FIG. 2 is viewed from the light guide rod side, FIG. 4A is a perspective view of the light emitting device when the light emitting device is viewed from the light guide rod side, and FIG. 4B is a sectional view taken along line IVB-IVB of the periphery of a heat sink illustrated in FIG. 4A.

When explaining with reference to these drawings, the light emitting device 15 includes a plurality of first light source units 31 mounted on a first substrate 21, a plurality of second light source units 41 mounted on a second substrate 22, a plurality of columnar light guide rods (light guide portion) 23 arranged adjacent to each other on a chassis 26, a first heat sink (heat dissipating member) 24 that holds the plurality of first light source units 31 at a predetermined position in parallel with the first substrate 21 and a first end portion 234 of the light guide rod 23, and a second heat sink 25 that holds the second light source unit 41 at a predetermined position in parallel with the second substrate 22 and a second end portion 237 of the light guide rod 23.

The first light source unit 31 is configured with three laser diodes (laser light sources) 31b, 31g, and 31r. The laser diode 31b emits a blue laser light beam (hereinafter, “(B) light beam”). The laser diode 31g emits a green laser light beam (hereinafter, “(G) light beam”). The laser diode 31r emits a red laser light beam (hereinafter, “(R) light beam”).

A second light source unit 41 is configured with three laser diodes 41r, 41g, and 41b. The laser diode 41r emits a (R) light beam. The laser diode 41g emits a (G) light beam. The laser diode 41b emits a (B) light beam.

The first light source unit 31 and the second light source unit 41 are respectively opposed to a first end surface 231 and a second end surface 235 of the light guide rod 23, and light emission centers of the laser diodes 31b, 31g, 31r, 41r, 41g, and 41b are positioned within the diameter of the light guide rod 23.

The light guide rod 23 includes the circular first end surface 231 and the circular second end surface 235. The axial direction of the light guide rod 23 extends in a longitudinal direction of the light emitting device 15.

In the present embodiment, the diameter of the light guide rod 23 is not particularly limited. For example, the diameter may be 0.5 mm to 20 mm, preferably, 3 mm to 15 mm. In addition, the material of the light guide rod 23 may be any material as long as the laser light beam emitted from each laser diode of the first light source unit 31 and the second light source unit 41 is guided. For example, as a base material (core material) configuring such a light guide rod 23, acrylic resins, polyurethane, and the like are mentioned. In addition, the refractive index of the material forming the light guide rod 23 is not particularly limited, and, for example, may be 1.44 to 1.55. Furthermore, a light guide rod 23 may be coated with a covering material (clad material) such as transparent Teflon (registered trademark) according to a need. At that time, the refractive index of the covering material is not particularly limited, and may be, for example, 1.33 to 1.44. Furthermore, the light guide rod 23 may include a diffusing material (not illustrated) for uniformly emitting the laser light.

The first heat sink 24 and the second heat sink 25 are formed of a metal such as aluminum or a metal member having good thermal conductivity such as an alloy. The first substrate 21 and the second substrate 22 are fixed to the first heat sink 24 and the second heat sink 25, respectively, via grease or an acrylic or silicone heat dissipation sheet (not illustrated). In addition, the first substrate 21 and the second substrate 22 are fixed to the first heat sink 24 and the second heat sink 25 with screws (not illustrated) or the like. In the present embodiment, the first heat sink 24 holds the first end portion 234 of the light guide rod 23 and the first light source unit 31, and is configured to dissipate heat generated from the first light source unit 31. In addition, the second heat sink 25 holds the second end portion 237 of the light guide rod 23, and is configured to dissipate heat generated from the second light source unit 41. When a second heat sink 25 side is specifically explained as an example for this configuration, a second light guide recess portion 43 for holding the light guide rod 23 and a second light source recess portion 45 for holding the second light source unit 41 are formed in the second heat sink 25. It is configured that a shape of the second light guide recess portion 43 corresponds to an outer shape of the second end portion 237 of the light guide rod 23, and when the second end portion 237 of the light guide rod 23 is inserted into the second light guide recess portion 43, the first end portion 234 of the light guide rod 23 is held at a predetermined position. In addition, it is configured that a shape of the second light source recess portion 45 corresponds to an outer shape of the second light source unit 41, and when the second light source unit 41 is inserted into the second light source recess portion 45, the second light source unit 41 is held at a predetermined position. Although not illustrated, on a first heat sink 24 side, a first light guide recess portion for holding the light guide rod 23 at a predetermined position and a first light source recess portion for holding the first light source unit 31 at a predetermined position, are formed. By configuring the first heat sink 24 and the second heat sink 25, it is possible to easily align the position of a light axis of the laser light beam emitted from each laser diode of the first light source unit 31 and the second light source unit 41 and the light guide rod 23, and it is possible for the laser light beam to be efficiently incident on the light guide rod 23. In the present embodiment, it is preferable that the first light guide recess portion, the second light guide recess portion 43, the first light source recess portion, and the second light source recess portion 45 be formed such that the light guide rod 23 and the first and second light source units 31 and 41 are arranged by being spaced from each other in a longitudinal direction of the light guide rod 23. With this, it is possible to suppress each cap (not illustrated) of the first and second light source units 31 and 41 from physically interfering with the light guide rod 23.

Details of Light Source Unit

Next, a laser light beam emitted from the laser diodes 31b, 31g, and 31r configuring the first light source unit 31 will be described in detail. Since the laser diodes 41b, 41g, and 41r configuring the second light source unit 41 are the same as the laser diodes 31b, 31g, and 31r except that arranged positions are different from those of the laser diodes 41b, 41g, and 41r, description thereof will be omitted.

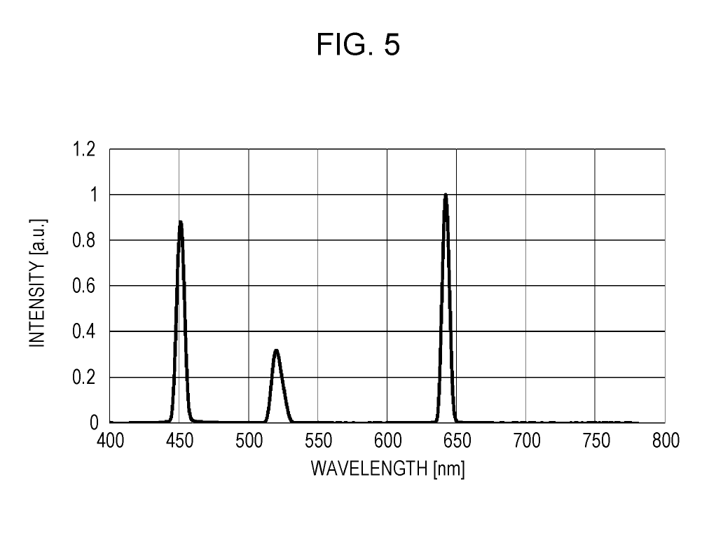

FIG. 5 is a graph illustrating an example of the relationship between the wavelength of the laser light emitted from the first light source unit 31 and light emission intensity peak.

When explaining with reference to FIG. 5, the laser diode 31b emits the laser light beam having the first intensity peak within a range of 440 nm to 477 nm. The laser diode 31g emits the laser light beam having a second intensity peak within a range of 505 nm to 542 nm. The laser diode 31r emits the laser light beam having a third intensity peak within a range of 620 nm to 660 nm. As an example of a preferable wavelength of the laser light beams emitted from the laser diodes 31b, 31g, and 31r, it is assumed that the laser diode 31b emits the laser light beam having the first intensity peak around 467 nm, the laser diode 31g emits the laser light beam having the second intensity peak in the periphery of 532 nm, and the laser diode 31r emits the laser light beam having the third intensity peak around 630 nm.

Action and Effect

Then, action and effect of the liquid crystal display device 1 and the light emitting device 15 will be described with reference to FIG. 2 to FIG. 4B again.

In the light emitting device 15, when emitting a (B) light beam, a (G) light beam, and a (R) light beam from the laser diodes 31b, 31g, and 31r of the first light source unit 31, these (B) light beam, (G) light beam, and (R) light beam are incident on a first end surface 231 of the light guide rod 23, and guided to the second light source unit 41. Meanwhile, when emitting a (R) light beam, a (B) light beam, and a (G) light beam from the laser diodes 41r, 41b, and 41g of the second light source unit 41, these (B) light beam, (G) light beam, and (R) light beam are incident on the second end surface 235 of the light guide rod 23, and guided to the first light source unit 31. Colors of the (G) light beam, the (B) light beam, and the (R) light beam are mixed in the light guide rod 23 and the mixed light is emitted from the light emitting device 15.

As described above, according to the light emitting device 15, since colors of three types of the laser light beams having different wavelengths are mixed in one light guide rod 23, color mixing property improves. In addition, since each of the light guide rod 23, the first light source unit 31, and the second light source unit 41 is held at a predetermined position by the first heat sink 24 and the second heat sink 25, the laser light emitted from the first light source unit 31 and the laser light emitted from the second light source unit 41 are efficiently incident on end surfaces of the light guide rod 23. Therefore, according to the present embodiment, since the number of parts may be reduced, it is possible to provide the light emitting device 15 and the liquid crystal display device 1 with a simple and efficient configuration in which the uniformity of white light is improved. Therefore, if the light emitting device 15 is used as the backlight, it is possible to realize the liquid crystal display device of a next generation type thin liquid crystal television or the like sufficiently corresponding to the color gamut standard (BT2020) demanded for 4K/8K broadcasting.

In the present embodiment, although the light emitting device including a plurality of light source units and a plurality of the light guide rods is described as an example, a configuration of the light emitting device of the present disclosure may adopt other configurations as long as a configuration in which at least one light source unit emitting three or more types of laser light beams having wavelengths different from each other, a light guide portion for guiding the laser light beams emitted from the light source unit, and a heat dissipating member for holding the light source unit and the light guide portion at predetermined positions and dissipating heat generated from the light source unit is provided. It is preferable to define predetermined positions such that the light source unit and the light guide portion are arranged by being spaced from each other in the longitudinal direction of the light guide portion.

In addition, in the present embodiment, although two light source units are opposed to both end surfaces of the light guide portion, in the light emitting device according to the present disclosure, the light source unit may be configured to oppose to only at least one end surface of the light guide portion. Considering that there is attenuation of the laser light beam in the light guide rod, it is desirable to make the laser light beam incident from both sides of the light guide rod. However, in a case where the consideration of attenuation of the laser light beam is not demanded, it is possible to reduce the number of parts and reduce the size of the whole device by disposing the light source unit so as to be opposed to only one end surface.

As described in the present embodiment, it is preferable that a configuration in which a plurality of light source sets each including the light source unit, the light guide rod, and the heat dissipating member, are provided be adopted from the viewpoint that the amount of light emitted from the light emitting device may be increased.

In addition, in the present embodiment, although the arrangement of the laser diode is different in the first light source unit and the second light source unit which are opposed to each other with the light guide rod interposed therebetween, the embodiment is not limited thereto. The color of the laser light beam emitted from the laser diode may be symmetrical in the first light source unit and the second light source unit which are opposed to each other with the light guide rod in between.

In addition, in the present embodiment, although the light guide rod is disposed along the longitudinal direction of the light emitting device, the embodiment is not limited thereto. The light guide rod may be disposed along a lateral direction of the light emitting device.

In addition, in the light emitting device according to the present disclosure, a configuration in which laser light beams exceeding three types of laser light beams with different wavelengths are emitted from the laser diodes, may be adopted. Therefore, for example, a configuration in which laser light beams of four colors including (B), (G), (R), and (Y) are incident on an end surface of the light guide rod by further providing the laser diode that emits a yellow (Y) laser light beam with respect to each of the first light source unit and the second light source unit, may be adopted. In this manner, it is possible to improve the luminance of the light emitted from the light emitting device and color gamut when passing through the liquid crystal panel. Alternatively, a configuration in which the laser light beams of four colors including (B), (G), (R), and (C) are incident on an end surface of the light guide rod by providing the laser diode that emits a laser light beam of cyan (C), may be adopted. In this manner, it is possible to improve the color gamut when the light emitted from the light emitting device passes through a liquid crystal panel (not illustrated). Alternatively, as a combination of the laser light beams in another embodiment, for example, a combination of (B), (C), (Y), and (R) beams, and a combination of (B), (C), (G), and (R) beams, and a combination of (B), (C), (G), (Y), and (R) beams, and the like may be adopted.

Furthermore, in the present embodiment, a display device may include a reflective sheet for reflecting the light from the light guide rod. Furthermore, instead of the reflective sheet, light emitted from the light guide rod may be reflected by coating a semi-circumferential surface of the light guide rod with a known reflective material.

Furthermore, in the light emitting device, a photodiode may be incorporated in the laser diode configuring the light source unit so as to control the amount of light emitted from each light source unit. Alternatively, by externally attaching one or more color sensors or the like to the light emitting device and controlling the amount of light emitted from each light source unit, the luminance and chromaticity of the light emitting device may be controlled.

Furthermore, the disposition of the chassis according to the present embodiment is not particularly limited, and the chassis may be disposed on either the inner side or the outer side of the substrate or the heat sink.

Furthermore, a shape of the light guide rod used in the light emitting device is not limited to the one described above, for example, the light guide rod, the heat sink, and the substrate may be modified as follows. In the modification examples described below, for convenience of explanation, members having the same functions as those described in the above embodiment are denoted by the same reference numerals, and description thereof will not be repeated.

### Modification Example of Light Guide Rod

A modification example of the light guide rod in the light emitting device of the present embodiment will be described.

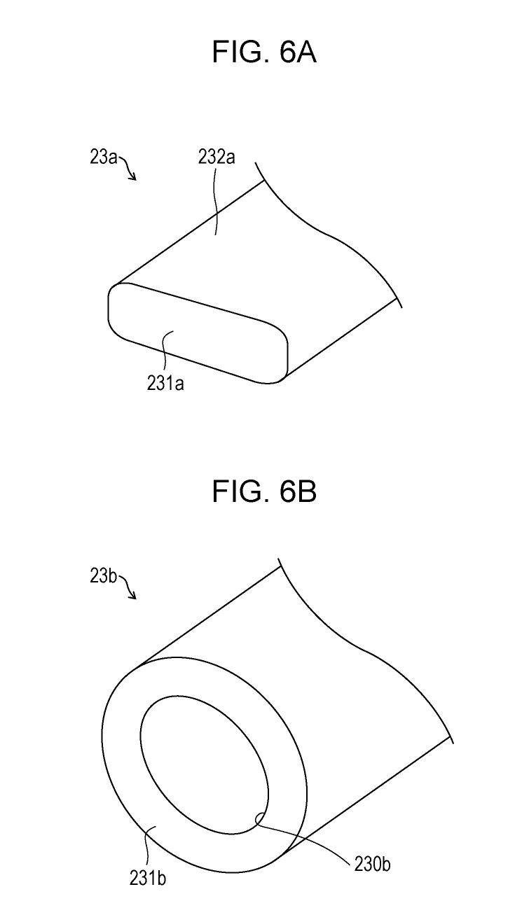

The shape of the light guide rod according to the present embodiment may be a columnar shape as described above or may be a shape having at least one flat portion along a longitudinal direction of the light guide rod. Furthermore, the light guide rod of the columnar shape may have a hollow portion inside thereof. These will be described with reference to FIGS. 6A and 6B. FIGS. 6A and 6B are schematic diagrams schematically illustrating a modification example of the light guide rod according to the present embodiment.

For example, when explaining with reference to FIGS. 6A and 6B, as illustrated in FIG. 6A, by providing a light guide rod 23a including a flat portion 232a along a longitudinal direction, the light guide rod 23a including a flat end surface 231a may be provided. Alternatively, as illustrated in FIG. 6B, by providing a columnar shape having a hollow portion 230b, a light guide rod 23b including a ring-shaped end surface 231b may be provided. If the shape of the end surface of the light guide rod is a shape illustrated in FIG. 6A, since the thickness of the module may be reduced, thinning of the light emitting device may be further realized. In addition, if the shape of the end surface of the light guide rod is a shape illustrated in FIG. 6B, it is possible to insert a sub-light guide rod (sub-light guide portion) such as a tube into a hollow portion of the light guide rod, and it is possible to adjust a color tone and the light amount of the light emitted from the light guide rod by the sub-light guide rod.

### Modification Example of Heat Sink

The first to the third modification examples of a heat sink according to the present embodiment will be described. For convenience of explanation, hereinafter, although the second heat sink will be described as an example, it is assumed that the first heat sink has the same configuration as that of the second heat sink (which will be described below).

### First Modification Example

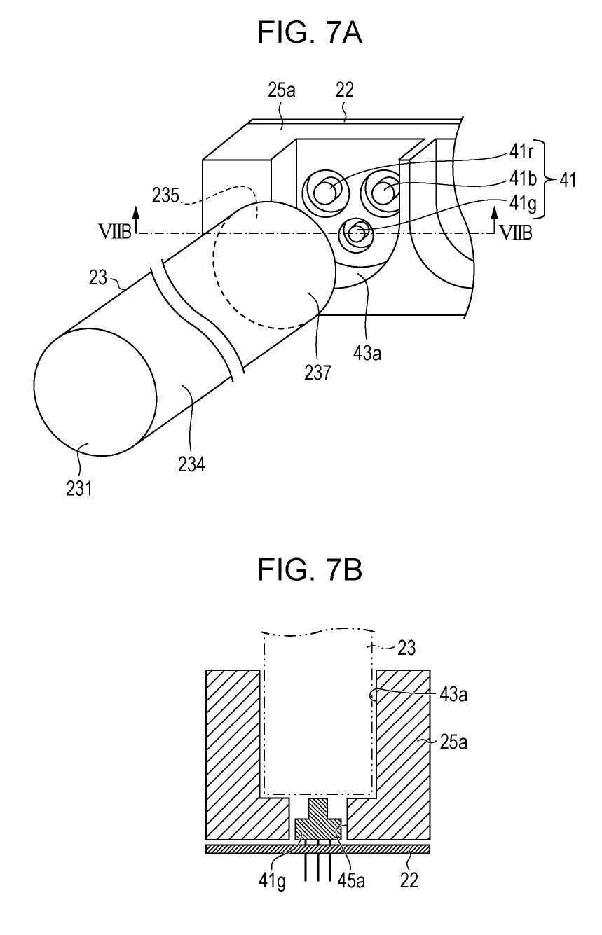

FIGS. 7A and 7B are diagrams for explaining a first modification example of the heat sink according to the present embodiment, FIG. 7A is a perspective view schematically illustrating part of a configuration of the periphery of the heat sink, and FIG. 7B is a sectional view taken along line VIIB-VIIB illustrated in FIG. 7A.

When explaining with reference to FIGS. 7A and 7B, in a second heat sink 25a, a second light guide recess portion 43a has a shape in which a part of the periphery of the light guide rod 23 is opened. Specifically, as illustrated in FIG. 7A, the second light guide recess portion 43a holding the light guide rod 23 is formed as a U-shaped groove shape. In addition, a second light source recess portion 45a for holding the second light source unit 41 is formed in the second heat sink 25a.

According to such a configuration, the light emitted from an end surface (not illustrated) of the light guide rod 23 is not blocked by the second heat sink 25a. Therefore, it is possible to use the light emitted from the light guide rod 23 entirely. In addition, by providing the second light guide recess portion 43a as the U-shaped groove shape, since the material configuring the heat sink 25a is reduced, it is possible to reduce the weight of the light emitting device and to reduce the material cost.

Furthermore, since a liquid crystal panel 10 (see FIG. 1) side is opened by the second light guide recess portion 43a, it is possible to accurately position the second light source unit 41 and the light guide rod 23 at the time of module assembly.

### Second Modification Example

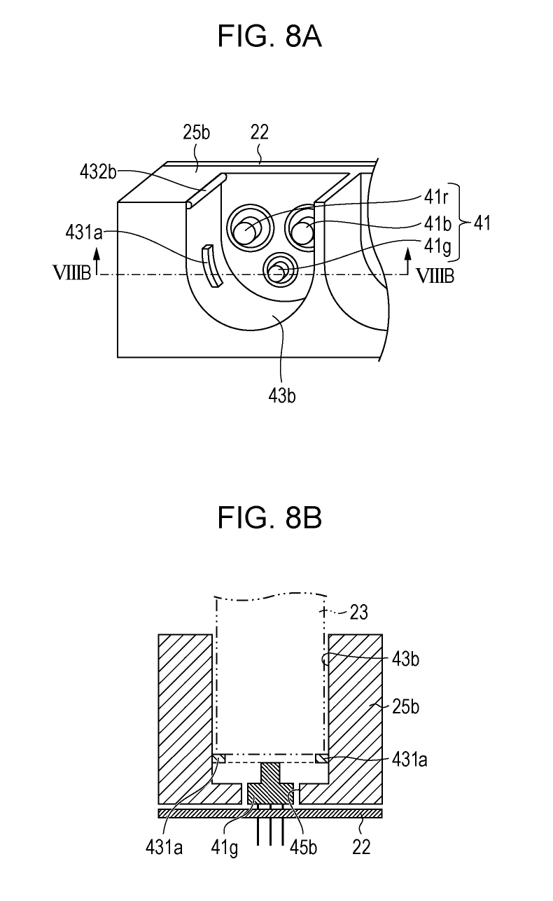

FIGS. 8A and 8B are diagrams for explaining a second modification example of the heat sink according to the present embodiment, FIG. 8A is a perspective view schematically illustrating part of a configuration of the periphery of the heat sink, and FIG. 8B is a sectional view taken along line VIIIB-VIIIB illustrated in 8A.

When explaining with reference to FIGS. 8A and 8B, in a second heat sink 25b, a second light guide recess portion 43b is formed as the U-shaped groove shape in which a part of the periphery of the light guide rod 23 is opened, similar to the heat sink 25a (see FIGS. 7A and 7B) according to the above-described first modification example. In addition, a second light source recess portion 45b for holding the second light source unit 41 is formed in the heat sink 25b. Furthermore, a stopper 431a is formed on an inner side surface of a U-shaped groove of the second light guide recess portion 43b. Furthermore, a protrusion portion 432b surrounding part of an outer periphery of the light guide rod 23 is formed on an open side of the second light guide recess portion 43b.

According to such a configuration, in addition to an effect obtained by a configuration of the heat sink 25a according to the first modification example, it is possible to suppress the light guide rod 23 inserted into the second light guide recess portion 43b from escaping to an open side of the light guide recess portion 43b by the protrusion portion 432b. Furthermore, it is ensured that the second light source unit 41 and the light guide rod 23 are arranged and spaced apart from each other in a longitudinal direction of the light guide rod 23 by the stopper 431a. For example, similar to the first modification example, an open side of the second light guide recess portion 43b may be restrained by a member such as sheet restraint (not illustrated).

In the protrusion portion, at least the light guide rod inserted into the light guide recess portion may be suppressed from escaping to an open side of the light guide recess portion. Therefore, the position, the shape, and the number of the protrusion portions are not limited to the examples of FIGS. 8A and 8B. In addition, the protrusion portion may also be applied to the first modification example which is described above or the third modification example which will be described below.

### Third Modification Example

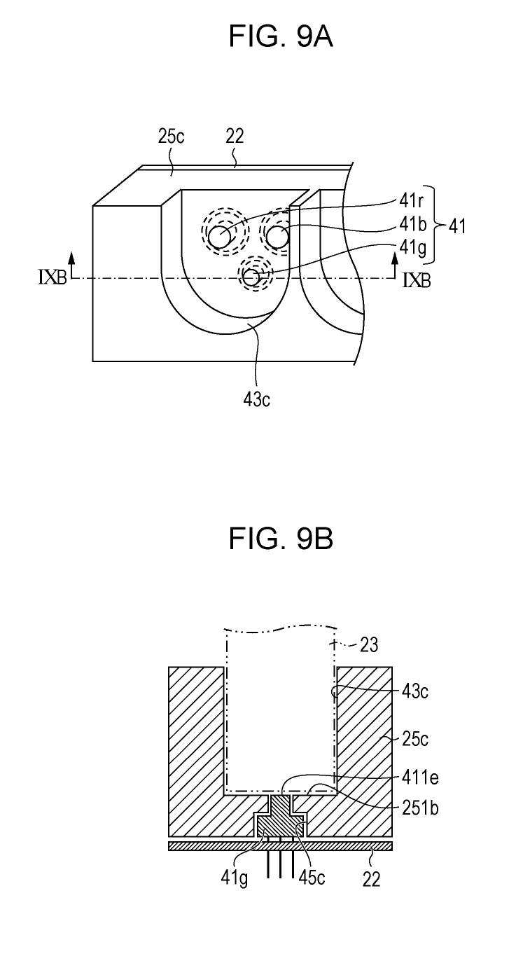

A third modification example according to the present embodiment will be described. FIGS. 9A and 9B are diagrams for explaining a heat sink according to a third modification example, FIG. 9A is a perspective view schematically illustrating part of a configuration of the periphery of the heat sink, and FIG. 9B is a sectional view taken along line IXB-IXB illustrated in FIG. 9A.

When explaining with reference to FIGS. 9A and 9B, a second light guide recess portion 43c for holding the light guide rod 23 and a second light source recess portion 45c for holding the second light source unit 41 are formed in a second heat sink 25c. The second light guide recess portion 43c has a shape in which a part of the periphery of the light guide rod 23 is opened, similar to the second heat sink 25a (see FIGS. 7A and 7B) according to the first modification example.

In the present modification example, the heat sink is configured such that a cap and a stem portion (not illustrated) of the laser diode of the second light source unit 41 are accommodated in the second light source recess portion 45c, and a light emitting end surface 411e of the second light source unit 41 and a heat sink end surface 251b on a light guide rod 23 side are flush with each other. According to such a configuration, for example, it is possible to avoid breakage or the like of the light emitting end surface 411e of the second light source unit 41 at the time of module assembly without having the stopper.

### Modification Example of Substrate

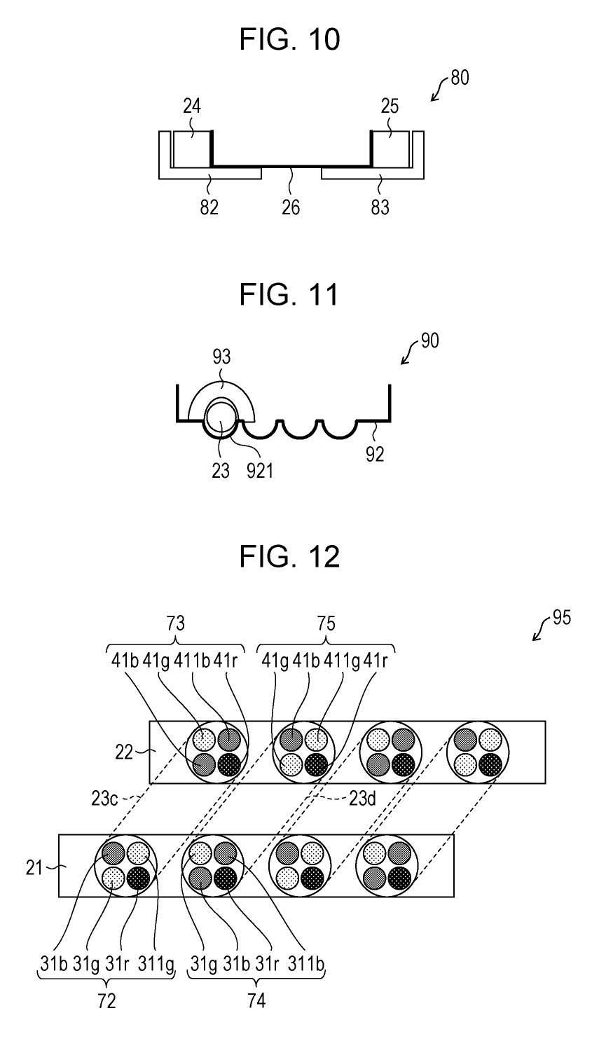

A first modification example of a substrate of the present embodiment will be described. FIG. 10 is a schematic diagram schematically illustrating part of the light emitting device including a substrate according to the modification example.

When explaining with reference to FIG. 10, in a light emitting device 80 according to the present embodiment, a first substrate 82 and a second substrate 83 are configured with a flexible substrate having copper foils (not illustrated) on both surfaces thereof. Part of the first substrate 82 and the second substrate 83 is folded to a side of the first heat sink 24 and the second heat sink 25, respectively, so as to follow the chassis 26. Furthermore, a wiring pattern (not illustrated) is formed on a rear surface side of a portion in contact with a stem portion (not illustrated) of the laser diode. At this time, the wiring pattern may include two layers or more of wiring layers (not illustrated).

According to such a configuration, by increasing a contact area between the first substrate 82 and the first heat sink 24 and a contact area between the second substrate 83 and the second heat sink 25, it is possible to efficiently dissipate the heat generated from the first light source unit 31 and the second light source unit 41 (see FIGS. 3, 4A, and 4B).

### Modification Example of Chassis

Then, a modification example of a chassis of the present embodiment will be described. FIG. 11 is a schematic diagram schematically illustrating part of the light emitting device including the chassis according to the modification example.

When explaining with reference to FIG. 11, in a light emitting device 90 according to the present embodiment, a receiving portion 921 corresponding to an outer shape of the light guide rod 23 is formed on a chassis 92. According to such a configuration, it is possible to easily position the light guide rod 23 with the receiving portion 921 as a mark. Furthermore, the light guide rod 23 is fixed to the chassis 92 by a transparent fastener 93 covering part of the outer periphery of the light guide rod 23. The material of the transparent fastener 93 is not specifically limited. For example, the material may be the same material as that of the light guide rod 23. By using such a transparent fastener 93, occurrence of quality problems such as luminance unevenness and color unevenness may be avoided by curving the light guide rod 23. Although not illustrated, the fastener may be integrally held together with the plurality of light guide rods.

### Embodiment 2

Another embodiment of the light emitting device of the present disclosure will be described below. For convenience of explanation, the same reference numerals are attached to members having the same functions as the members described in the above embodiment, and description thereof will not be repeated.

The light emitting device according to the present embodiment has a configuration (hereinafter, it is referred to as “first configuration”) in which the laser light emitted from one light source unit includes a set of lasers having the same wavelength. Furthermore, the light emitting device according to the present embodiment has a configuration (hereinafter, it is referred to as “second configuration”) in which a plurality of sets including one light guide rod and the first light source unit and the second light source unit opposed to each other via one light guide rod are included and the combination of the laser light sources in the first light source unit differs from the combination of the laser light sources in the second light source unit. Furthermore, the light emitting device according to the present embodiment has a configuration (hereinafter, it is referred to as “third configuration”) in which a plurality of the light source set are included, the light source set includes a first light source set and a second light source set, the first light source set and the second light source set are alternately arranged adjacent to each other, and the combination of the wavelengths of the laser light beams emitted from the first light source set differs from the combination of the wavelengths of the laser light beams emitted from the second light source set. Such a configuration will be described below in detail.

FIG. 12 is a schematic diagram schematically illustrating part of a light emitting device according to Embodiment 2 of the present disclosure.

When explaining with reference to FIG. 12, in a light emitting device 95 of the present embodiment, a first light source set includes a first light source unit 72, a second light source unit 73, a light guide rod 23c, and the first heat sink (first heat dissipating member) (not illustrated). The second light source set includes a first light source unit 74, a second light source unit 75, a light guide rod 23d, and the second heat sink (second heat dissipating member) (not illustrated).

The first light source units 72 and 74 are alternately arranged adjacent to each other on the first substrate 21. Meanwhile, the second light source units 73 and 75 are alternately arranged adjacent to each other on the second substrate 22. The first light source unit 72 is configured with the laser diodes 31b, 31g, and 31r, and a laser diode 311g emitting the laser light beam having the same wavelength as that of the laser diode 31g. The first light source unit 74 is configured with the laser diodes 31g, 31b, and 31r, and a laser diode 311b emitting the laser light beam having the same wavelength as that of the laser diode 31b. The laser diodes 311g and 311b are arranged on the first substrate 21.

Meanwhile, the second light source unit 73 is configured with the laser diodes 41g, 41b, and 41r, and a laser diode 411b emitting the laser light beam having the same wavelength as that of the laser diode 41b. In addition, the second light source unit 75 is configured with the laser diodes 41b, 41g, and 41r, and a laser diode 411g emitting the laser light beam having the same wavelength as that of the laser diode 41g. The laser diodes 411b and 411g are mounted on the second substrate 22.

In the present embodiment, the first light source unit 72 and the second light source unit 73 are opposed to each other with the light guide rod 23c in between. In addition, the first light source unit 74 and the second light source unit 75 are opposed to each other with the light guide rod 23d in between.

According to such a configuration, it is possible to compensate for the insufficient light amount of the laser light as the whole module. In addition, the first light source units 72 and 74, and the second light source units 73 and 75 are arranged adjacent to each other so as to alternately be repeated on a side of the first substrate 21 and the second substrate 22, respectively, such that the color unevenness is eliminated and the color mixing property is further improved.

Although the present embodiment includes the first to the third configurations described above, the present embodiment is not limited thereto, and may include any one of the first to the third configurations. In addition, in the third configuration, each light source set may include one light source unit.

In addition, in the first light source unit 72 and the second light source unit 73 opposed to each other with the light guide rod 23c in between, and the first light source unit 74 and the second light source unit 75 opposed to each other with the light guide rod 23d in between, a combination of the laser diodes is not limited to one described in the present embodiment.

### Embodiment 3

Further other embodiment of the light emitting device of the present disclosure will be described below. For convenience of explanation, the same reference numerals are attached to members having the same functions as the members described in the above embodiment, and description thereof will not be repeated.

The light emitting device according to the present embodiment has a configuration in which a plurality of the light source sets and a plurality of sub-light source sets, the sub-light source sets each including a sub-light source unit and the sub-light guide portion in which the monochromatic light emitted from the sub-light source unit is guided, are included, and the light source set and the sub-light source set are alternately arranged adjacent to each other. Such a configuration will be described below in detail.

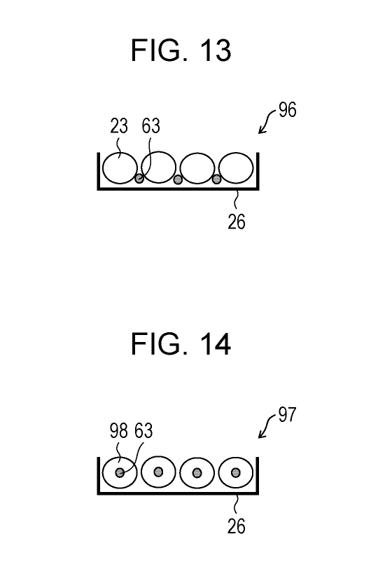

FIG. 13 is a schematic diagram schematically illustrating part of the light emitting device according to Embodiment 3 of the present disclosure.

When explaining with reference to FIG. 13, a light emitting device 96 includes a plurality of light source sets including the first light source unit (not illustrated), the light guide rod 23, and the first heat dissipating member (not illustrated) and a plurality of sub-light source sets each including the sub-light source unit (not illustrated) and a sub-light guide rod 63 (sub-light guide portion) in which the monochromatic light emitted from the sub-light source unit is guided. The light source set and the sub-light source set are alternately arranged adjacent to each other.

In such a light emitting device 96, if, for example, the laser light beam of (B), the laser light beam of (G), and the laser light beam of (R) emitted from the light source unit are guided to the light guide rod 23, and the (R) light beam emitted from the sub-light source unit is guided to a sub-light guide rod 63, it is possible to avoid deterioration of white balance (phenomenon in which white light emitted from light emitting device changes to cyan) after light emission of the light emitting device.

### Embodiment 4

Further other embodiment of the light emitting device of the present disclosure will be described below. For convenience of explanation, the same reference numerals are attached to members having the same functions as the members described in the above embodiment, and description thereof will not be repeated.

FIG. 14 is a schematic diagram schematically illustrating part of the light emitting device according to Embodiment 4 of the present disclosure.

When explaining with reference to FIG. 14 and FIG. 6B, a light emitting device 97 includes a plurality of light guide rods 98, the light source unit (not illustrated), a plurality of sub-light source units (not illustrated), and a plurality of sub-light guide rods 63. The light guide rod 98 has a cylindrical shape including the hollow portion illustrated in FIG. 6B, and a ring-shaped end surface shape, and a sub-light guide rod 63 is inserted into the hollow portion of a light guide rod 98.

In the light emitting device 97 of such a configuration, for example, the laser light beam of (R), the laser light beam of (G), and the laser light beam of (B) emitted from the light source unit may be guided to an end surface of the light guide rod 98, and the (R) light beam may be guided to the sub-light guide rod 63.

### CONCLUSION

The light emitting device 15 according to an aspect 1 of the present disclosure holds at least one light source unit (first light source unit 31) emitting three or more types of laser light beams having wavelengths different from each other, the light guide rod 23 in which the laser light beams are guided, and the heat dissipating member (first heat sink 24) for holding the light source unit (first light source unit 31) and the light guide rod 23 at predetermined positions and dissipating heat generated from the light source unit (first light source unit 31).

According to the configuration, since the laser light beams having different wavelengths emitted from the light source unit (first light source unit 31) are effectively incident on the light guide rod 23 and the colors of the laser light beams are mixed in the light guide rod 23, the color mixing property improves. In addition, since the light source unit (first light source unit 31) and the light guide rod 23 are held at predetermined positions by the heat dissipating member (first heat sink 24), it is possible to reduce the number of light emitting members. Therefore, according to the configuration, it is possible to provide the light emitting device 15 that may realize uniform surface emission with a simple and efficient configuration.

The light emitting device 15 according to an aspect 2 of the present disclosure may have a configuration in which the light source unit (first light source unit 31) is opposed to at least one end surface of the light guide rod 23 in the aspect 1.

According to the configuration, it is possible to effectively guide the laser light from the light source unit (first light source unit 31) to the light guide rod 23.

The light emitting device 95 according to an aspect 3 of the present disclosure may have a configuration in which the heat dissipating member (first heat sink 24) includes the light guide recess portion for holding the light guide rod 23 and at least one light source recess portion for holding the light source unit (first light source unit 31) in the aspect 1 or 2.

According to the configuration, it is possible to hold the light source unit 31 and the light guide rod 23 by a simple configuration.

The light emitting device 15 according to an aspect 4 of the present disclosure, it is preferable that the light source unit (first light source unit 31) and the light guide rod 23 be arranged by being spaced from each other in the longitudinal direction of the light guide rod 23, in any one of the aspects 1 to 3.

According to the configuration, it is possible to avoid physical interference between the light source unit (first light source unit 31) and the light guide rod 23.

In the light emitting device according to an aspect 5 of the present disclosure, the light emitting end surface 411e of the light source unit and the heat sink end surface 251b may be flush with each other, in any one of the aspects 1 to 4.

According to the configuration, it is possible to avoid the breakage or the like of the light emitting end surface 411e of a light source unit at the time of module assembly.

In the light emitting device according to an aspect 6 of the present disclosure, the light guide recess portion 43a may include a shape in which a part of the periphery of the light guide rod 23 is opened, in the aspect 3.

According to the configuration, it is possible to accurately perform the positioning of the light source unit (first light source unit 31) and the light guide rod 23.

In the light emitting device according to an aspect 7 of the present disclosure, a plurality of light source sets each including the light source unit (first light source unit 31), the light guide rod 23, and the heat sink (first heat sink 24), in any one of the aspects 1 to 6.

According to the configuration, it is possible to increase the amount of the light emitted from the light emitting device.

In the light emitting device according to an aspect 8 of the present disclosure, the laser light beams emitted from the light source unit 72 may include a set of laser light beams having an identical wavelength in any one of the aspects 1 to 7.

In addition, the light emitting device according to an aspect 9 of the present disclosure may have a configuration in which a plurality of sets each including one light guide portion (light guide rod 23c or 23d), and the first light source unit 72 or 74 and the second light source unit 73 or 75 which are opposed to each other with one light guide portion interposed therebetween, are included, and a combination of the laser light sources (laser diodes 31b, 31g, 31r, and 311g, or 31g, 31b, 31r, and 311b) in the first light source unit differs from a combination of the laser light sources (laser diodes 41g, 411b, 41r, and 41b, or 41b, 41g, 41r, and 411g) in the second light source unit, in any one of the aspects 1 to 8.

According to the configuration, it is possible to compensate for the insufficient light amount of the laser light as the whole module.

The light emitting device according to an aspect 10 of the present disclosure may include a plurality of the above-described light source sets and a plurality of sub-light source sets each including a sub-light source unit and a sub-light guide portion (sub-light guide rod 63) in which monochromatic light emitted from the sub-light source unit is guided, and the light source set and the sub-light source set may be alternately arranged adjacent to each other, in the aspect 7 or 8.

According to the configuration, it is possible to avoid deterioration of white balance after light emission of the light emitting device.

The light emitting device according to an aspect 11 of the present disclosure may include a plurality of the above-described light source sets, the light source set may include the first light source set and the second light source set, the first light source set and the second light source set may be alternately arranged adjacent to each other, and a combination of the wavelengths of the laser light beams emitted from the first light source set may differ from a combination of the wavelengths of the laser light beams emitted from the second light source set, in the aspect 7 or 8.

According to the configuration, it is possible to improve the color mixing property between the light guide rods (light guide rod 23 and sub-light guide rod 96) adjacent to each other.

The light emitting device according to an aspect 12 of the present disclosure, in any one of the aspects 1 to 8, has a configuration in which the sub-light source unit emitting the laser light beam different from the laser light beam emitted from the light source unit and the sub-light guide rod 63 in which the laser light beam emitted from the sub-light source unit is guided are included, each of the light guide rods 98 has a cylindrical shape having the hollow portion, and the sub-light guide rod 63 is inserted into the hollow portion.

According to the configuration, it is possible to adjust the color tone and the light amount of the light emitted from the light guide rod 23 by the sub-light guide rod 63.

The light emitting device according to an aspect 13 of the present disclosure may have a configuration in which the light guide rod has the columnar shape or at least one flat portion 232a along the longitudinal direction of the light guide rod, in any one of the aspects 1 to 12.

According to the configuration, by adjusting the shape of the light guide rod, it is possible to realize further thinning of the light emitting device.

The light crystal display device according to an aspect 14 of the present disclosure includes the light emitting device according to any one of the above-described aspects as the backlight.

According to the configuration, a compact liquid crystal display device 1 with improved white light uniformity may be provided.

The present disclosure is not limited to the above-described embodiments, and various modifications are possible within the scope indicated in the claims, and embodiments obtained by appropriately combining technical means each disclosed in different embodiments are also included in the technical scope of the present disclosure. Furthermore, by combining technical means disclosed in each embodiment, new technical features may be formed.

The present disclosure contains subject matter related to that disclosed in Japanese Priority Patent Application JP 2017-194504 filed in the Japan Patent Office on Oct. 4, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A light emitting device comprising:
at least one light source unit that emits three or more types of laser light beams having wavelengths different from each other;
a light guide portion in which the laser light beams are guided; and
a heat dissipating member that holds the light source unit and the light guide portion at predetermined positions, and dissipates heat generated from the light source unit.

2. The light emitting device according to claim 1,
wherein the light source unit is opposed to at least one end surface of the light guide portion.

3. The light emitting device according to claim 1,
wherein the heat dissipating member includes a light guide recess portion for holding the light guide portion and at least one light source recess portion for holding the light source unit.

4. The light emitting device according to claim 1,
wherein the light source unit and the light guide portion are arranged by being spaced from each other in a longitudinal direction of the light guide portion.

5. The light emitting device according to claim 1,
wherein a light emitting end surface of the light source unit and an end surface, on a side of the light guide portion, of the heat dissipating member are flush with each other.

6. The light emitting device according to claim 3,
wherein the light guide recess portion has a shape in which a part of a periphery of the light guide portion is opened.

7. The light emitting device according to claim 1, further comprising:
a plurality of light source sets each including the light source unit, the light guide portion, and the heat dissipating member.

8. The light emitting device according to claim 1,
wherein the laser light beams emitted from the light source unit include a set of laser light beams having an identical wavelength.

9. The light emitting device according to claim 1, further comprising:
a plurality of sets each including one light guide portion, a first light source unit, and a second light source unit, the light source unit, and the second light source unit being opposed to each other with the one light guide portion interposed therebetween,
wherein a combination of laser light sources in the first light source unit differs from a combination of laser light sources in the second light source unit.

10. The light emitting device according to claim 7, further comprising:
a plurality of sub-light source sets each including a sub-light source unit and a sub-light guide portion in which monochromatic light emitted from the sub-light source unit is guided,
wherein each of the plurality of light source sets and each of the plurality of sub-light source sets are alternately arranged adjacent to each other.

11. The light emitting device according to claim 7,
wherein the plurality of light source sets includes a first light source set and a second light source set, the first light source set and the second light source set being alternately arranged adjacent to each other, and a combination of wavelengths of laser light beams emitted from the first light source set differs from a combination of wavelengths of laser light beams emitted from the second light source set.

12. The light emitting device according to claim 1, further comprising:
a sub-light source unit that emits a laser light beam with a wavelength different from the laser light beam emitted from the light source unit; and
a sub-light guide portion in which the laser light beam emitted from the sub-light source unit is guided,
wherein the light guide portion has a cylindrical shape having a hollow portion, and
the sub-light guide portion is inserted into the hollow portion.

13. The light emitting device according to claim 1,
wherein the light guide portion has a columnar shape or a shape including at least one flat portion along a longitudinal direction of the light guide portion.

14. A liquid crystal display device comprising:
a light emitting device as a backlight, the light emitting device including
at least one light source unit that emits three or more types of laser light beams having wavelengths different from each other,
a light guide portion in which the laser light beams are guided, and
a heat dissipating member that holds the light source unit and the light guide portion at predetermined positions, and dissipates heat generated from the light source unit.
